(19) United States
(12) Patent Application Publication
(10) Pub. No.: US 2018/0294826 A1
(43) Pub. Date: Oct. 11, 2018

(54) RADIO TRANSCEIVER AND RADIO COMMUNICATION SYSTEM

(71) Applicant: MIMOTECH (PTY) LTD., Retreat (ZA)

(72) Inventors: Stephanus Jacobus FOUCHE, Cape Town (ZA); Emile VAN ROOYEN, Cape Town (ZA)

(73) Assignee: Mimotech (Pty) Ltd., Retreat (ZA)

(21) Appl. No.: 15/522,605

(22) PCT Filed: Oct. 26, 2015
(86) PCT No.: PCT/ZA2015/050017

§ 371 Date: Apr. 27, 2017

(30) Foreign Application Priority Data
Oct. 30, 2014 (ZA) 2014/07934

(51) Int. Cl. H04B 1/10; H04B 1/40; H04L 5/14; H04L 25/02

(52) U.S. Cl. CPC H04B 1/10; H04L 25/0202; H04L 5/14; H04B 1/40

(57) ABSTRACT

A wireless radio transceiver (610) has at least one radio transmitter (613, 614) and at least one radio receiver (616, 617), and a transmitter 611; 662) antenna coupled to the transmitter (613, 614) and a neighbouring receiver antenna (612) coupled to the receiver (616, 617), the transmitter and receiver antennas (611, 612) being disposed adjacent to each other such that a space is defined therebetween, the transmitter and receiver antennas (611, 612) being configured to communicate simultaneously with a remote radio transceiver (660). The wireless radio transceiver (610) also has i) electromagnetic wave attenuation material (811) which is disposed at least partially within the space defined between the transmitter and receiver antennas (611, 612) (for minimising direct antenna-to-antenna interference) and ii) a reflection interference cancellation digital signal processing module (621) which is configured to cancel interference in a signal received by the receiver (616, 617), wherein the interference is as a result of reflection of a signal (602) transmitted by the transmitter (613, 614) (for minimising reflected or indirect antenna-to-antenna interference).

### FIELD OF INVENTION

This invention relates generally to radio transceivers and more particularly to an ultra-high capacity radio transmission system employing simultaneous bidirectional communication.

### BACKGROUND OF INVENTION

Data network traffic has grown at around 100% per year for over twenty years. Only transport over optical fibre has shown the ability to keep pace with this increasing data capacity demand for networks. With the advent of 4G, LTE-A and 5G, the demand for data is expected to grow at an exponential rate. It is often impractical and too expensive to connect high-bandwidth data networking points by way of optical fibre.

A Point-to-Point (PtP) communication system uses two radios, one at each of two locations. When the two radios are working together, these are referred to as a “radio link”. PtP radio links are used worldwide to carry continuous bidirectional digital data in public and private networks. Point-to-point microwave radio systems are well known in the state of the art. They have been defined, for example, in the European Standard ETSI EN 302 217-2-2 V2.2.0: “Fixed Radio Systems; Characteristics and requirements for point-to-point equipment and antennas”. Microwave radio links can be employed, in particular, instead of a wired connection between elements of a network for which a fixed connection is desired.

A Time Division Duplex (TDD), point-to-point microwave communication system uses the same frequency to either transmit or receive data in different time slots. A Frequency Division Duplex (FDD) system, on the other hand, simultaneously transmits and receives data kit transmission and reception of data occurs at different frequencies. For example, a conventional FDD microwave link uses a first frequency for transmission and a second frequency for reception of signals. Using the same frequency for simultaneous transmission and reception in a conventional (non-TDD) wireless system results in significant self-interference at the receiver thereby rendering the system ineffective in receiving the desired signal.

The Applicant desires a point-to-point radio system which at least alleviates the above drawbacks and preferably provides simultaneous full-duplex communication capabilities.

### SUMMARY OF INVENTION

In accordance with the invention, there is provided a wireless radio transceiver which includes:
at least one radio transmitter and at least one radio receiver;
a transmitter antenna coupled to the transmitter and a neighbouring receiver antenna coupled to the receiver, the transmitter and receiver antennas being disposed adjacent to each other such that a space is defined therebetween, the transmitter and receiver antennas being configured to communicate simultaneously with a remote radio transceiver;
electromagnetic wave attenuation material which is disposed at least partially within the space defined between the transmitter and receiver antennas; and
a reflection interference cancellation digital signal processing module which is configured to cancel interference in a signal received by the receiver, wherein the interference is as a result of reflection of a signal transmitted by the transmitter.

The transceiver may further include a radome which is operatively arranged over the transmitter and receiver antennas, the radome including an electromagnetic wave attenuating portion which is operatively in register with the space defined between the transmitter antenna and the receiver antenna.

The transmitter and the receiver (referred to as the transmitter/receiver pair) may be configured to transmit and receive, respectively, data within the same frequency band. The radio transceiver may be configured simultaneously to transmit and receive data via the transmitter/receiver pair.

The transceiver may be configured to communicate with the remote radio by way of a point-to-point configuration.

The transmitter and receiver antennas being cross-polarised antennas. In such case, the transceiver may include a pair of transmitters coupled to the transmission antenna via a transmit OMT (Orthogonal Mode Transducer) and a pair of receivers coupled to the reception antenna via a receive OMT (Orthogonal Mode Transducer).

The reflection interference cancellation module may be an adaptive digital signal processing module. The digital signal processing module may employ channel estimation.

The invention extends to a radio communication system which includes a pair of radio transceivers as described above. The transceivers may be arranged in a point-to-point configuration.

The transceivers may be configured for full duplex communication. Furthermore, the transceivers may be configured for bidirectional, simultaneous communication within the same frequency band.

The transceivers may be configured to communicate using Orthogonal Frequency Domain Multiplexing (OFDM) modulation or Single Carrier (SC) Modulation.

The wireless radio transceiver may include a DSP (Digital Signal Processor). The DSP may be operable to:
transmit, using the transmitter, a training signal to a remote wireless radio transceiver whilst the receiver is not communicating with the remote wireless radio transceiver;
receive, using the receiver, an interference signal following transmission of the training signal; and
calculate an interference correction signal which operatively is used to cancel interference on a signal received by the receiver.

The invention extends to a method of optimising spectral efficiency of a proximate radio transceiver which includes at least one transmitter/receiver pair comprising a transmitter and a neighbouring receiver which are configured simultaneously to communicate with a remote radio transceiver, the method including:
transmitting, using the transmitter of the proximate radio transceiver, a training signal to a receiver of the remote radio transceiver whilst the receiver of the proximate radio transceiver is not communicating with the remote radio transceiver;
receiving, using the receiver of the proximate radio transceiver, an interference signal following transmission of the training signal by the transmitter; and
calculating an interference correction signal which operatively is used to cancel interference on a signal received by the receiver.

The invention further extends to a method of optimising spectral efficiency of a proximate radio transceiver which includes at least one transmitter/receiver pair comprising a transmitter and a neighbouring receiver which are configured simultaneously to communicate with a remote radio transceiver, the method including:
training the receiver by transmitting a training signal to the remote radio transceiver using the transmitter;
estimating an interference, correction signal using a DSP module of the proximate radio transceiver;
initiating simultaneous transmission by the transmitter and reception by the receiver; and
correcting a signal received by the receiver using information derived from the interference correction signal.

The step of calculating or estimating an interference correction signal may include performing channel estimation. This step may include estimating a cancellation Finite Impulse Response (FIR) using channel estimation.

The step of correcting a signal received by the receiver may include subtracting a manipulated version of the transmitted signal from the received signal. More specifically, the step of correcting may involve subtracting a combination of delayed and weighted versions of the transmitted signal from the received signal. The step of correcting the received signal may be adaptive. Information derived from the received signal following channel estimation may be used to control manipulation of the transmitted signal used for correcting the received signal.

The interference signal may be caused by reflection of the training signal or transmitted signal off near-field objects or structures.

The invention extends to a method of optimising spectral efficiency of a radio communication system comprising at least two remotely spaced apart radio transceivers configured to communicate via a communications link, each radio transceiver including at least one transmitter/receiver pair comprising a transmitter and a neighbouring receiver which are configured simultaneously to communicate with the remote radio, the method including:
training the receiver of a proximate radio transceiver by transmitting a training signal to the receiver of the remote radio transceiver, using the transmitter;
estimating an interference correction signal using a DSP module of the radio;
initiating simultaneous transmission by the transmitters of both radio transceivers; and
correcting a signal received by the receivers using information derived from the interference correction signal.

The interference correction signal may be in the form of an estimated cancellation FIR response.

The step of calculating an interference correction signal may include a digital signal processing step performed by a reflective interference cancellation module.

The digital signal processing step may include:
taking a digital representation of a time domain received signal and converting the signal to the frequency domain in order to perform channel estimation.

The method may further include providing an electromagnetic wave attenuating material between the transmitter and receiver of the radio transceiver.

Any of the methods defined above may be implemented by the wireless radio transceiver or communication system as defined above.

### BRIEF DESCRIPTION OF THE DRAWINGS

The invention will now be further described, by way of example, with reference to the accompanying schematic drawings.

In the drawings:

FIG. 1 illustrates a high-level block diagram of a typical PRIOR ART Time Domain Duplex (TDD) radio;

FIG. 2 shows a high-level block diagram of a PRIOR ART Frequency Domain Duplex (FDD) radio;

FIG. 3 illustrates a high-level block diagram of a typical PRIOR ART cross-polarisation radio;

FIG. 4 shows an exemplary schematic block diagram of a PRIOR ART co-channel interference rejection circuit for a wireless communication device;

FIG. 6 shows a high-level block diagram of a point-to-point radio communication system in accordance with the invention;

FIGS. 6A-6C illustrate a side view and partial face on view, respectively, of a passive microwave absorbing material positioned in a space between antennas of a radio of FIG. 5;

FIG. 7A shows a logarithmic graph of signal power fed into a circular waveguide port of the transmitting antenna of FIG. 6a;

FIG. 7B shows a received interference signal at a circular waveguide port of the receive antenna of FIG. 6a, without the microwave absorbing material fitted;

FIG. 7C shows a received interference signal at the circular waveguide port of FIG. 7B including the microwave absorbing material;

FIG. 8 illustrates a flow diagram of a method of cancelling reflective interference in accordance with the invention; and

FIGS. 9A-9A illustrate a detailed functional block diagram of the radio communication system of FIG. 5.

### DETAILED DESCRIPTION OF AN EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

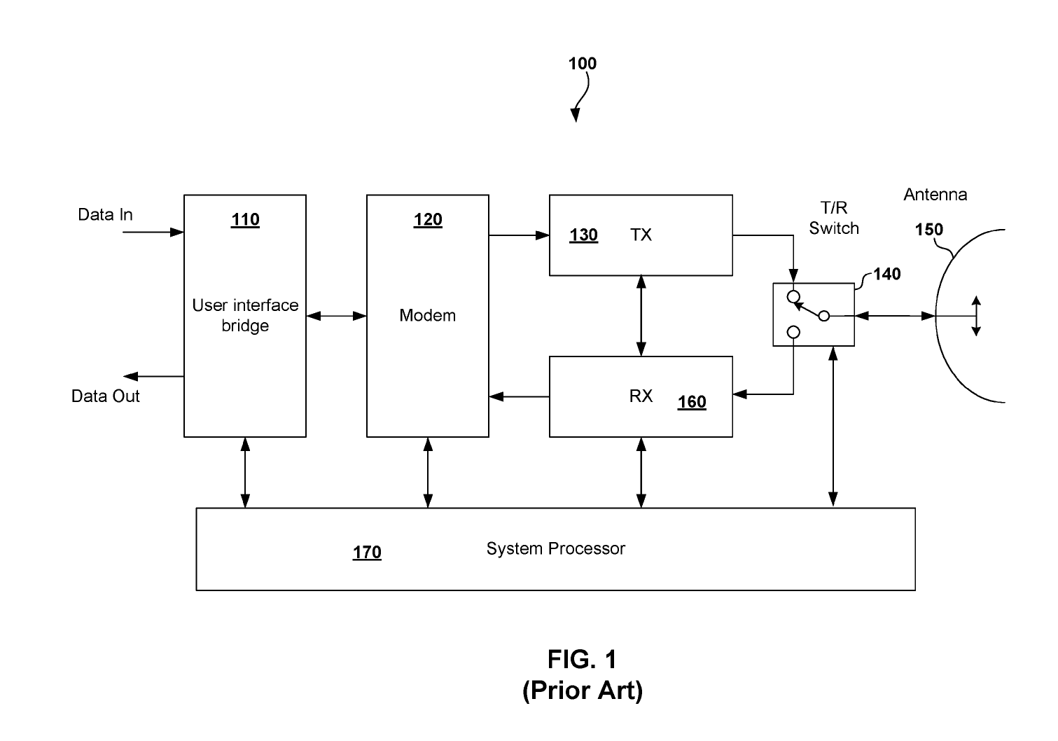

In FIG. 1, reference numeral 100 refers generally to a Time Domain Duplex (TDD) radio forming part of the PRIOR ART. It is to be appreciated that a TDD communication system consists of two identical radios 100 operating at the same frequency. Each radio 100 consists of a user interface bridge 110, a modem 120, a transmitter (TX) 130, a transmit/receive switch (T/R) 140, an antenna 150, a receiver (RX) 160 and a system processor 170. Transmission and reception occur in different time slots. During alternating transmission and reception cycles, the transmit/receive switch (TR) switches the antenna between transmission and reception paths of the radio 100.

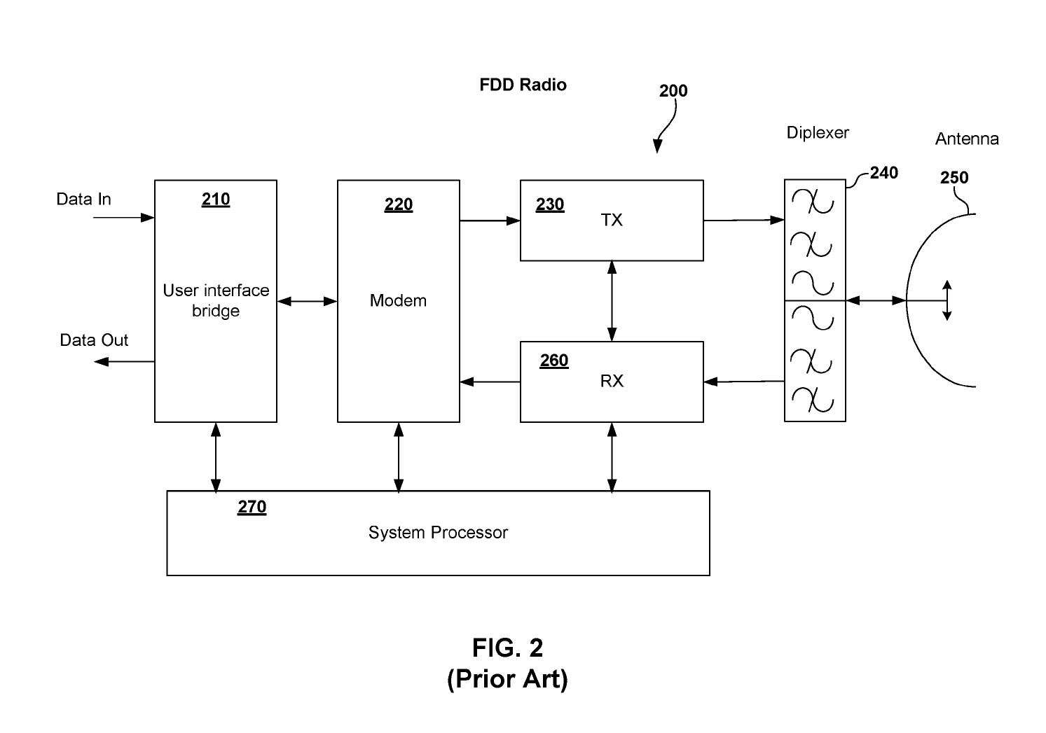

In FIG. 2, reference numeral 200 designates a PRIOR ART Frequency Domain Duplex (FDD) radio which includes a user interface bridge 210, a modem 220, a transmitter (TX) 230, a diplexer 240, an antenna 250, a receiver (RX) 260, and a System Processor 270. For a licensed band point-to-point system, Frequency Domain Duplex (FDD) communication may be required.

Several PRIOR ART design technologies can be employed to increase available data rates. The first is to increase the number of data bits sent per Hz of bandwidth (bps/Hz) by increasing the modulation complexity. Secondly, the amount of channel bandwidth (MHz) used can be increased. Advances in the modulation complexity and digital processing techniques have resulted in increased bps/Hz but this places demands on system parameters such as improved (Signal-to-Noise Ratio) SNR and ultimately results in diminishing returns as higher and higher orders of modulation are employed. Available bandwidth is limited and is controlled by various regulatory bodies and is ultimately limited to spectral density and occupation in a particular area.

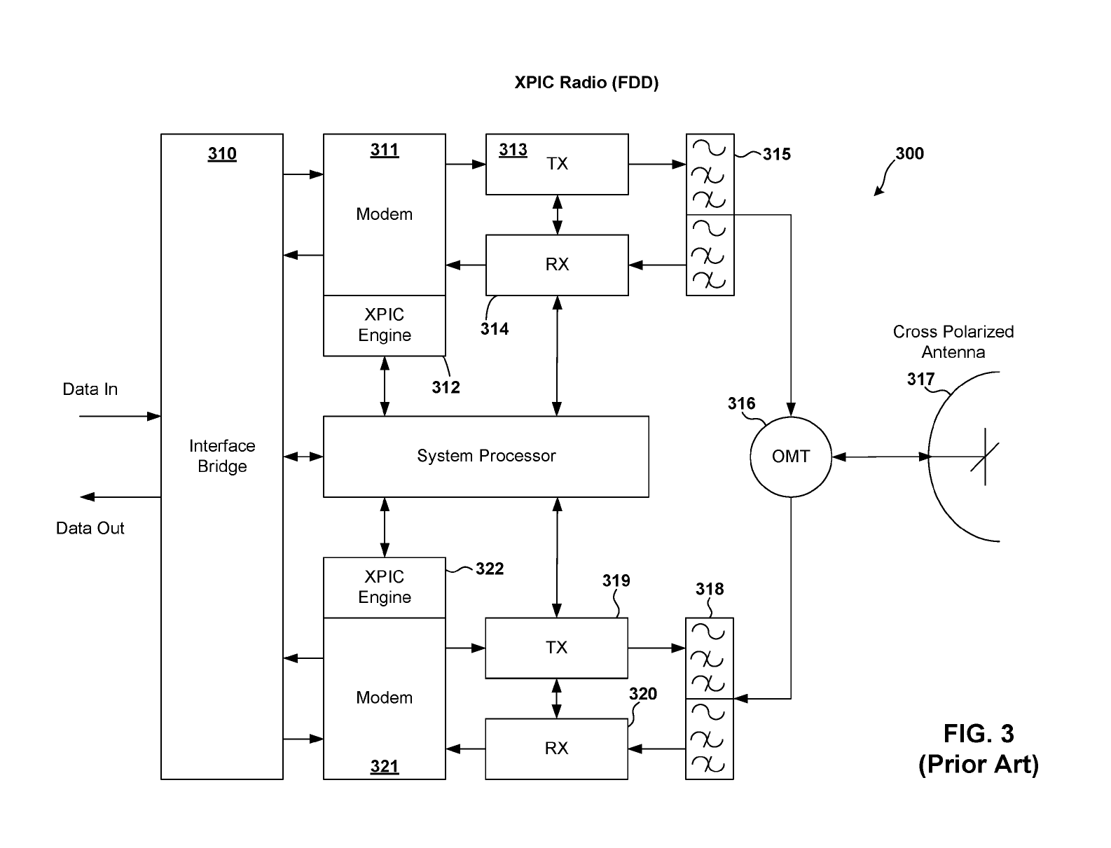

In FIG. 3, reference numeral 300 refers generally to a PRIOR ART cross-polarisation radio which essentially includes two FDD transceivers that operate at the same frequency. It is also known to use both horizontal and vertical polarisations with digital processing techniques such as cross polarisation interference cancellation (“XPIC”). The output of one transceiver is orthogonal (cross-polarised) to the other and the respective outputs are combined in a Orthogonal Mode Transducer (OMT) 316. The radio 300 includes a common interface bridge 310, two modems 311, 321 with integrated XPIC engines 312, 322, two transmitters 313, 319, two receivers 314, 320, two diplexers 315, 318, the OMT 316 and finally a cross-polarised antenna 317. This radio configuration 300 gives a 100% increase in spectral efficiency compared to the conventional FDD radio 200.

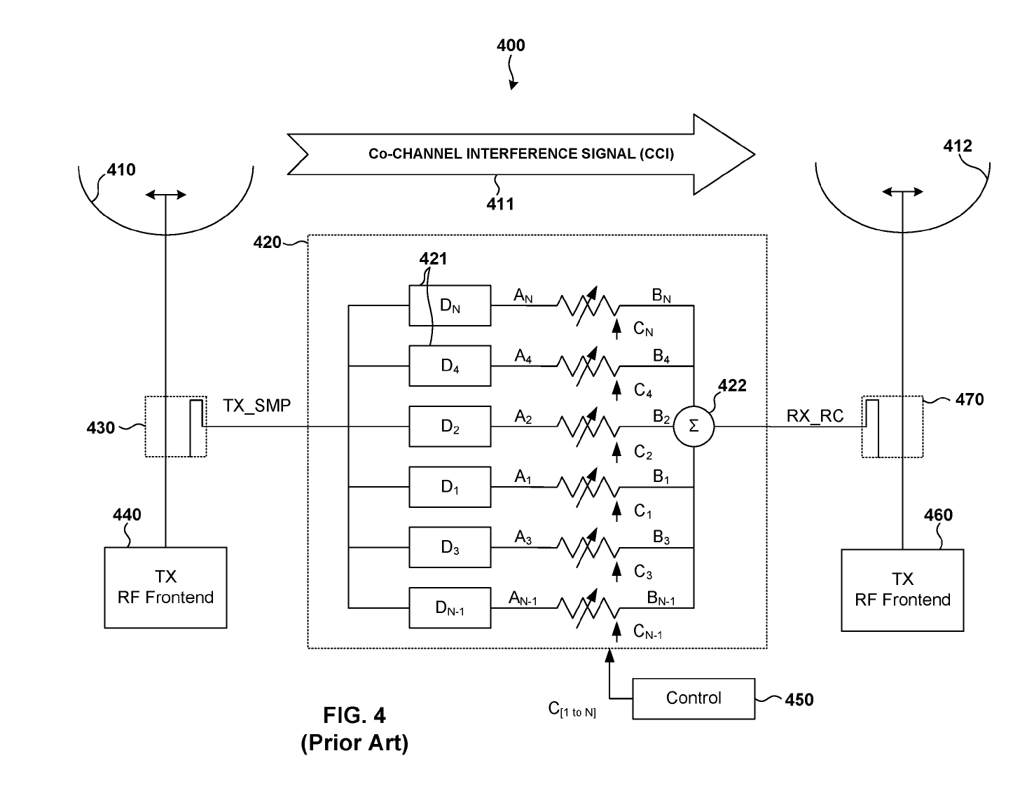

Several methods for achieving simultaneous bidirectional transmission and reception have been developed. Most of the disclosed methods are based on active RF cancellation techniques to achieve an initial level of required isolation. In FIG. 4, reference numeral 400 refers to a PRIOR ART co-channel interference rejection circuit for a wireless communication device which includes an antenna 412 for receiving and a transmission antenna 410 and a signal cancellation circuit 420 adapted to cancel or reduce a self-interference signal 411. The cancellation circuit 420 includes, in part, a control block 450, ‘N’ delay and attenuation paths 421, a combiner 422, and a subtractor 470.

Each path 421 includes a delay element and an associated variable attenuator whose attenuation level varies in response to the control block. Each path 421 receives a sample of the transmit signal from a RF coupler 430 and generates a delayed and weighted version of the sample signal. The combiner 422 is adapted to combine the ‘N’ delayed and weighted versions of the sample signal to construct a signal representative of a first portion of the self-interference signal 411. The subtractor 470 is adapted to subtract the constructed signal from a received signal. In this configuration, RF cancellation takes place at the microwave transmission and reception level resulting in the use of highly complex and expensive digitally controlled microwave circuits. No commercially viable product in the point-to-point radio market using this technology has reached the market yet, to the best of the Applicant's knowledge.

Implementation of the above methods and/or systems adds significant hardware cost, manufacturing complexity and logistic challenges to the equation. There is therefore a need for a point-to-point radio system that will at least alleviate the problems associated with current systems without significantly increasing cost of ownership.

In FIG. 5, reference numeral 600 refers generally to a point-to-point communication system in accordance with the invention. The communication system 600 includes a first wireless radio transceiver (referred to as the first radio) 610 and a second wireless radio transceiver (referred to as the second radio) 660. The first radio 610 includes a first pair of cross-polarised antennas 611, 612 and the second radio 660 also includes a second pair of cross-polarised antennas 661, 662. The antennas 611, 612, 661, 662 are configured to communicate via wireless communication links 601, 651. All the antennas 611, 612, 661, 662 are standard cross-polarised parabolic dish antennas (ETSI Class 3).

The first radio 610 comprises two linear transmitters 613 and 614 that have a wide operating bandwidth. The transmitters 613, 614 are respectively coupled to an Orthogonal Mode Transducer (OMT) 615. An orthogonally polarised signal from the OMT 615 is fed to the cross-polarised antenna 611 using a circular-waveguide coupling structure. The polarised signal is transmitted over the link 601 to the second radio 660 which is configured to receive the orthogonally polarised signal via the antenna 661, which in turn is coupled to another OMT 665 again using a circular-waveguide coupling structure. Two signals from the OMT 665 are then coupled to respective receivers 663, 664. The receivers 663, 664 are linear and have a wide operating bandwidth. The first and second radios 610, 660 are identical and therefore a signal transmitted from radio B 660 to radio A 610 follows a similar signal path using transmitters 666, 667 which are coupled to an OMT 668 and antenna 662.

Accordingly, it will noted that each of the radios 610, 660 has a transmitter/receiver pair, with each transmitter/receiver pair composed of two transmitters 613, 614; 666, 667 and two receivers 616, 617; 663, 664.

At the first radio 610, input data 609 is coupled to a modem and Digital Signal Processing (DSP) unit 620 which, in turn, is coupled to the transmitters 613, 614 providing Orthogonal Frequency Domain Multiplexed (OFDM) or Single Carrier (SC) signals with 2×2 Multiple Input Multiple Output (MIMO) encoding or Cross Polarized Interference Canceled (XPIC) signals for transmission via the transmission path described above. A signal received by the antenna 612 is fed to receivers 616, 617 via an OMT 618. The receivers 616, 617, in turn, feed two signals to the modem and DSP unit 620 which performs OFDM or SC dem odulation, 2×2 MIMO or XPIC decoding and DSP functions with the output data being presented at 608. The DSP unit 620 also contains a reflection interference cancelling (RIC) engine 621, to cancel any interfering signals 602 which may have reflected from object(s) 603 in or near the signal path of the transmitted signal 601.

At the second radio 660, the received signal from the antenna 661 is fed to receivers 663, 664 respectively via the OMT 665. The receivers 663, 664 in turn feed the signals to a modem and DSP unit 670 which performs OFDM or SC demodulation, 2×2 MIMO or XPIC decoding and DSP functions whilst output data is presented at 659. User input data 658 is coupled to the modem and DSP unit 670 which in turn is coupled to transmitters 666 and 667, providing OFDM or SC modulated signals with 2×2 MIMO encoding for transmission via the OMT 668 and antenna 662. The DSP unit 670 also contains a reflection interference cancelling (RIC) engine 671, to cancel any interfering signals 652 reflecting from object(s) 653 in the signal path of transmitted signal 651.

For a given distance of operation, antenna port-to-port isolation (represented respectively by numerals 604, 654 indicating isolation distances between respective antennas 611, 612; 661, 662) must be sufficiently higher than a signal path loss between the antenna 611 and the antenna 661, on the one hand, and between the antenna 662 and the antenna 612, on the other hand. The port-to-port isolation requirement is defined as follows:

I_{A}≥PL_{AB}+SNR_{MOD}

I_{B}≥PL_{BA}+SNR_{MOD}
where:
I_{A}=port-to-port isolation between antennas 611 and 612
I_{B}=port-to-port isolation between antennas 662 and 661
PL_{AB}=total path-loss between antennas 611 and 661
PL_{BA}=total path-loss between antennas 662 and 612 and
SNR_{MOD}=Signal to Noise Ratio required by each demodulator for zero bit error rate (BER).

In accordance with the present invention, methods were developed to obtain the required isolation between transmit and receive antennas of each radio 610, 660 to enable the radios 610, 660 to operate at full capacity over distances equivalent to their PRIOR ART counterparts.

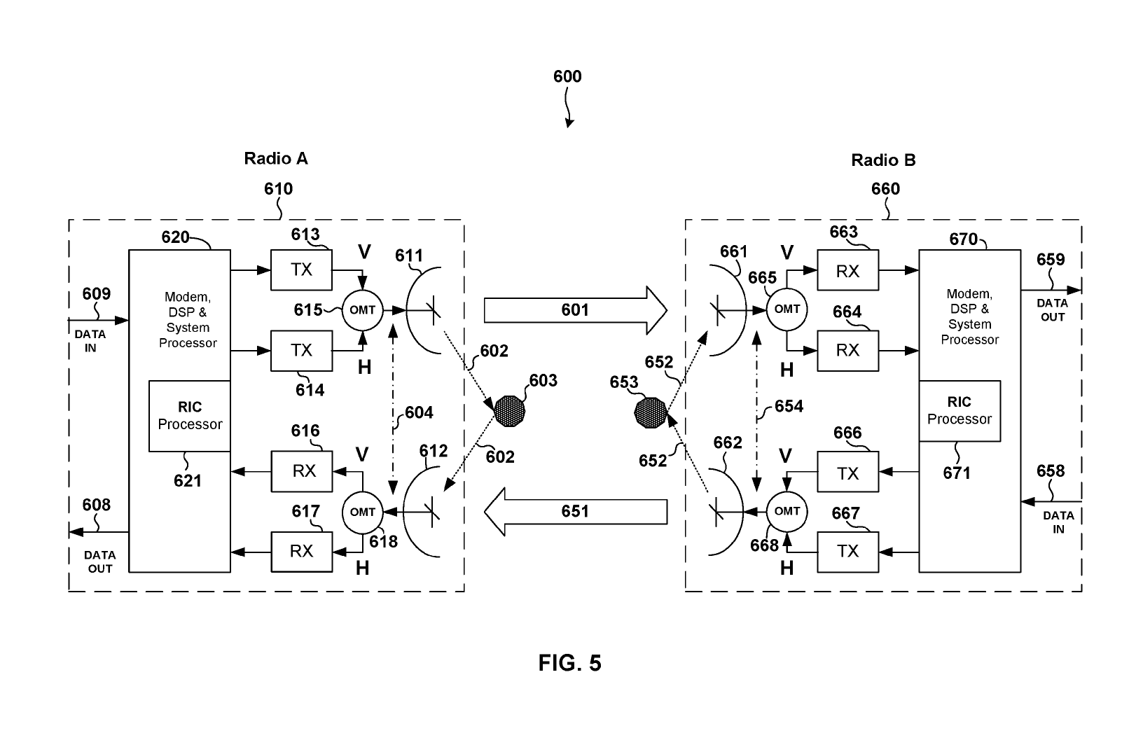

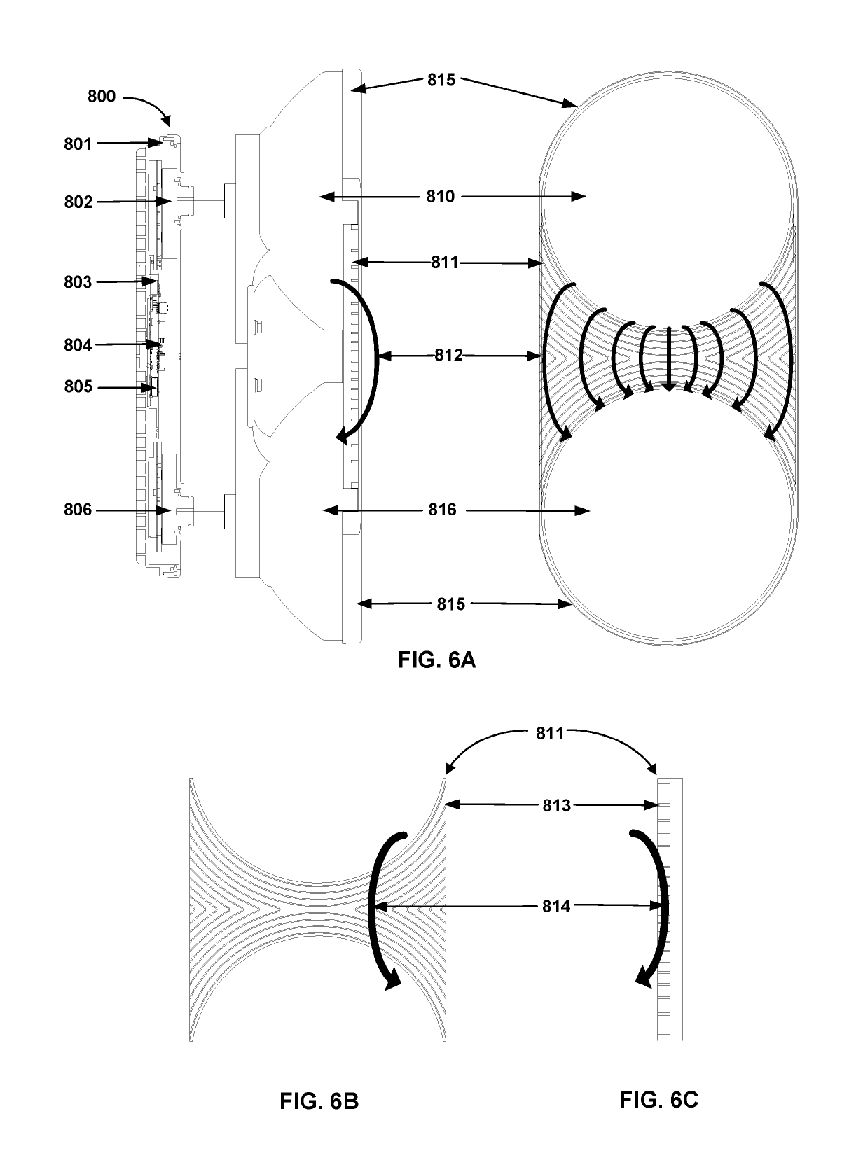

FIGS. 6A-6C illustrate the mechanical integration of a radio 800 (which may be either of the radios 610, 660) including a pair of antennas 810, 816 with a passive microwave absorbing structure 811 (made of cross-linked, closed cell, expanded polyethylene foam with strips of electromagnetic wave attenuation material imbedded in the foam at predetermined radial distances) positioned in a space between the antennas 810, 816 in order to ensure the required level of isolation between the antennas 810, 816 is achieved. The shape and the material composition of this structure 811 effectively absorbs and/or attenuates microwave energy resulting from surface waves 812 that may be generated and propagate across an aperture edge of the antennas 810, 816.

FIGS. 6B and 6C illustrate detail of the microwave absorbing structure or material 811 fitted in the radome 815 which physically covers both the transmission and reception antennas 810 and 816. The radiation absorbing structure 811 embedded in the radome 815 area between the antennas 810, 816 attenuates the microwave energy 812 and prevents it from reaching the receiving antenna 816. This is achieved by placing successive strips of microwave absorbant material 813 in thep foam 814 at pre-determined distances to prevent propagation 812 of the unwanted coupling wave between the antennas. By using this innovative construction and design technique, conventional (off the shelf) parabolic dish antennas (meeting ETSI Class 3 certification) can be used to obtain in excess of 100 dB of isolation.

The radio 800 includes all elements in a cost effective housing 801. The housing 801 includes separately RF-shielded transmitter 802 and receiver modules 806, a modem 805, data interface switch 803 and system processor 804. An important requirement of the design was that the largest physical dimension of the integrated radio 800 had to be less than 0.9 m. This enables exemption from any environmental impact studies required in the UK and Europe prior to deployment and use.

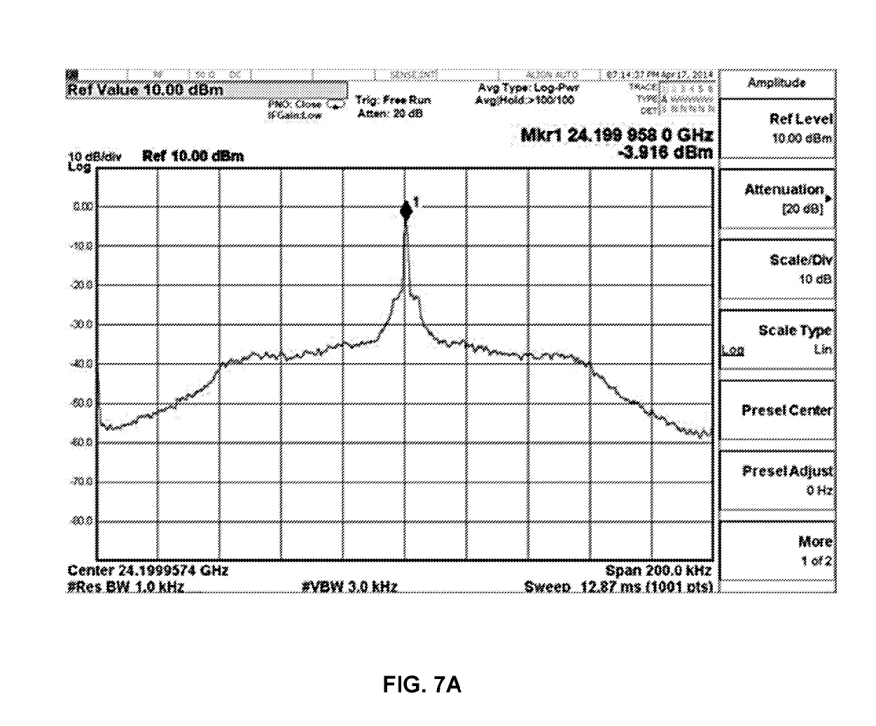

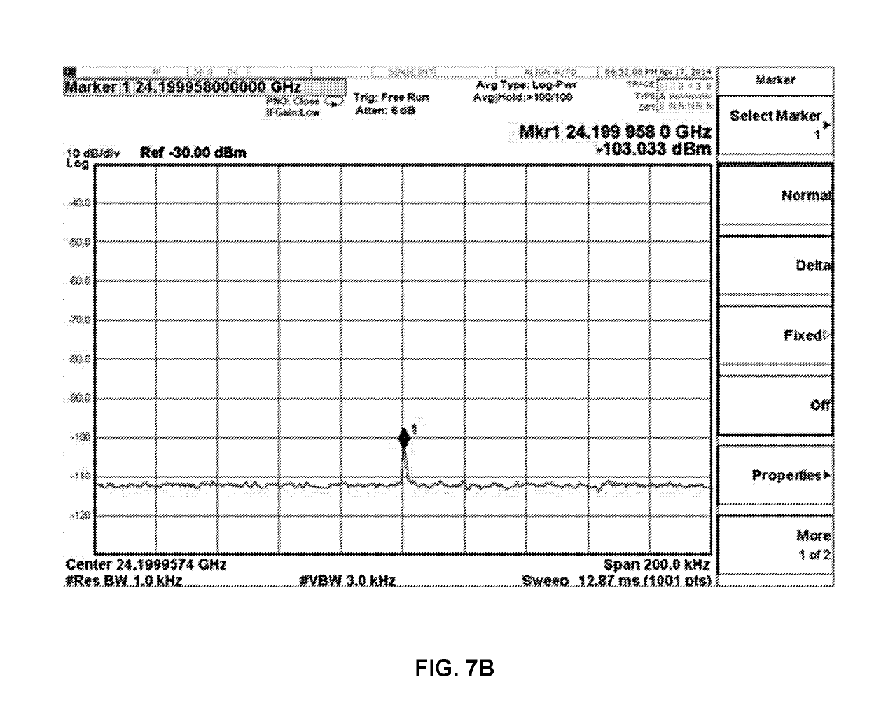

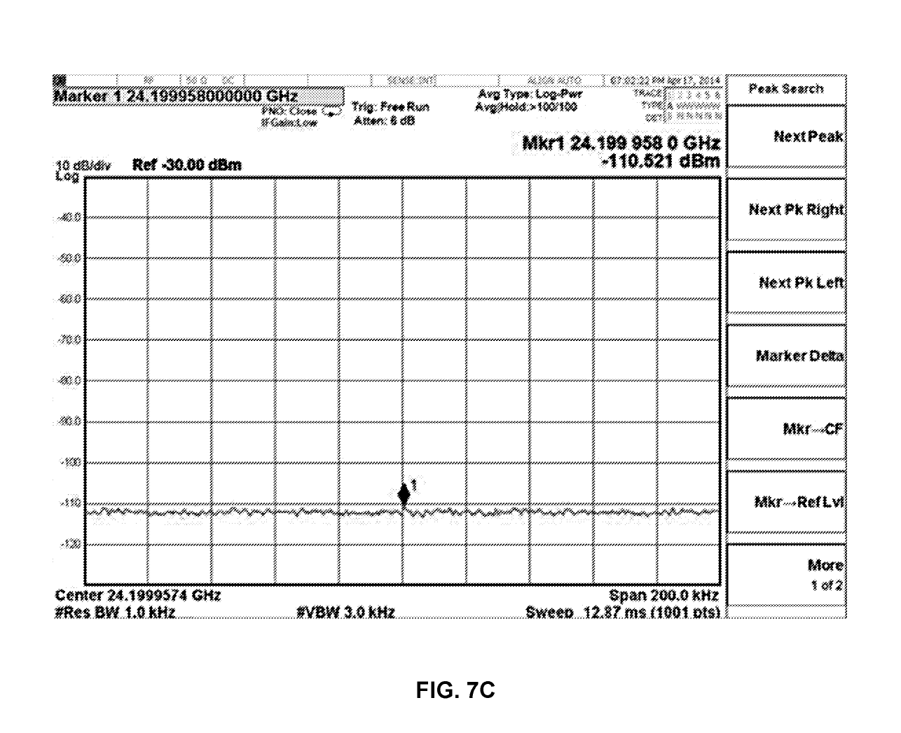

FIG. 7A shows a logarithmic graph of signal power fed into a circular waveguide port 820 of the transmitting antenna 810 at a level of −3.96 dBm.

FIG.7B shows a received interference signal at the circular waveguide port 821 of the receive antenna 816 at a level of −103.03 dBm giving a total port-to-port isolation of 99.07 dB without the microwave isolation structure 811 fitted.

FIG.7C shows a received interference signal at the circular waveguide port 821 of the receive antenna 816 at a level of −110.52 dBm giving a total port to port isolation of 106.56 dB with the microwave isolation structure 811 fitted.

With reference to FIG.5, the transmitted signals from each radio's antenna 611, 662 may encounter reflective objects 603, 653 such as mounting structures on towers or other objects in the antenna's near-field or close by in a spatial corridor, which is reflected back 602, 652 into the radio's receive antennas 612, 661. This reflection interference may significantly reduce the SNR at the receivers 616, 617 and therefore limit the range of the system 600. This interference signal is effectively cancelled by the reflection interference cancelling engine 621, 671 which will be discussed in more detail below.

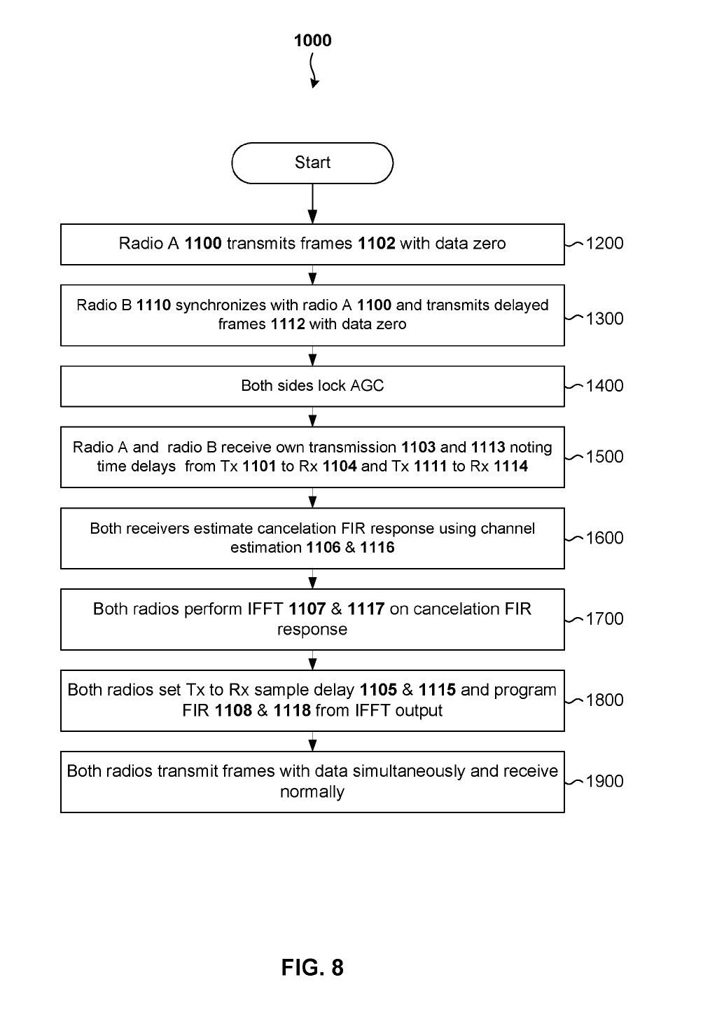

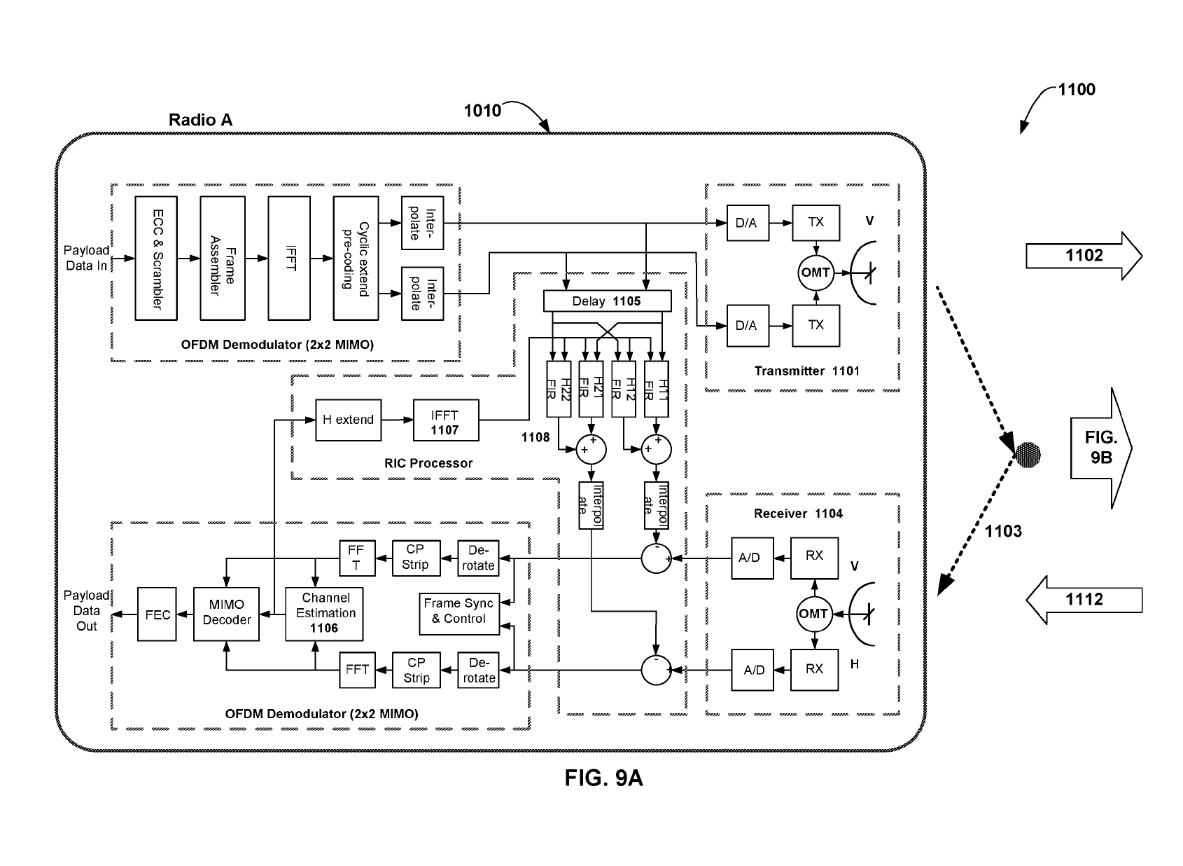

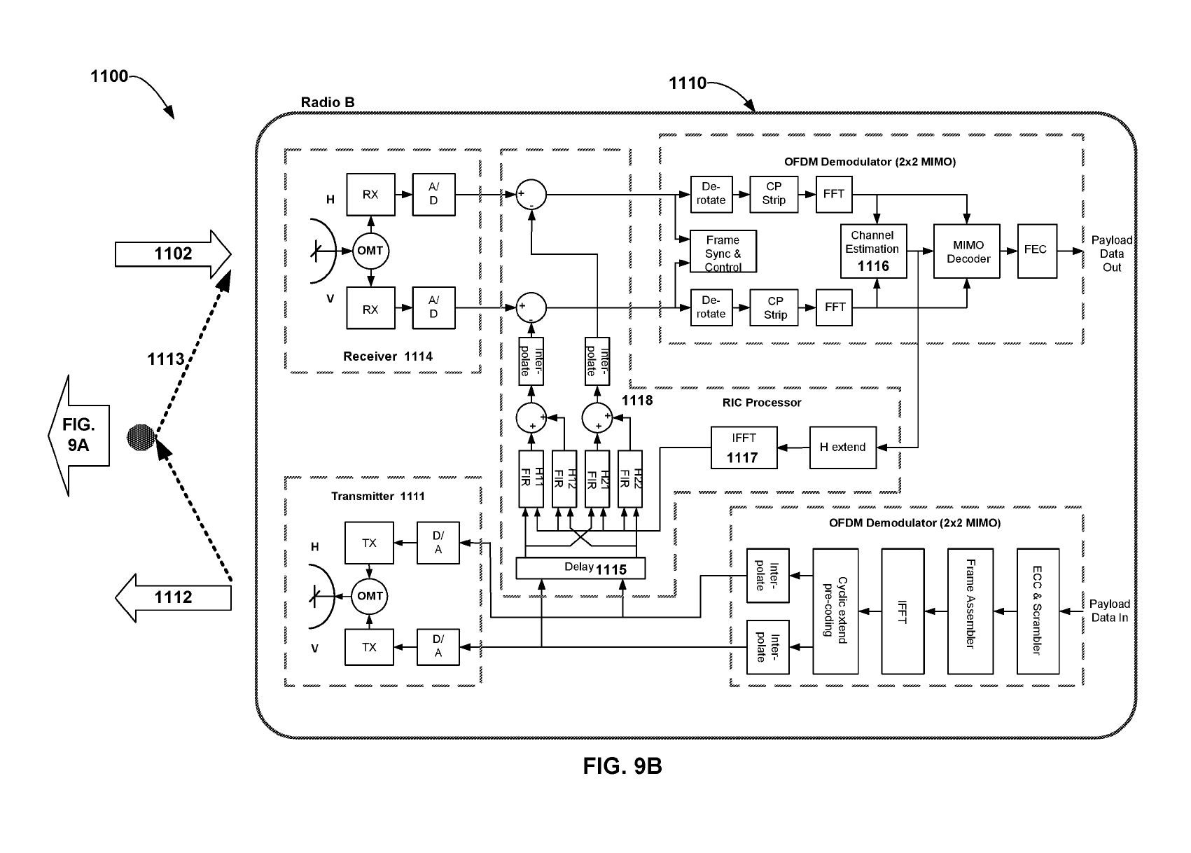

Reference is now made to FIG.8 and 9. In FIG.8, reference numeral 1000 refers generally to a method of cancelling reflective interference in a radio communication system, such as the system 600 of FIG.5. In FIG.9, reference numeral 1100 refers generally to a more detailed functional block diagram of the radio communication system 600 of FIG.5. The communication system 1100 includes two radios, radio A 1010 and radio B 1110. Each radio includes a transmitter and receiver pair 1101, 1104 and 1111, 1114, an OFDM or SC modem and a reflection interference cancellation module or processor 1108, 1118. The transmitter 1101 of radio A 1010 is configured to communicate with the receiver 1114 of radio B 1110 by way of communication link 1102 and the transmitter 1111 of radio B 1110 with the receiver 1104 of radio A 1010 via link 1112. Each transmitter/receiver 1101, 1104; 1111, 1114 has a conventional cross-polarised antenna. OFDM, Single Carrier (SC), and XPIC, are well known in the state of the art and will therefore not be expounded upon herein.

In order to train the system 1100, radio A 1010 transmits, at block 1200 (see FIG.8) a training signal. During transmission by the transmitter of radio A 1010, the transmitter 1111 of radio B is inactive (for non-simultaneous transmission). Following this step, radio B 1110 synchronises with radio A 1010 and also transmits, at block 1300 a training signal to radio A 1010. Both radios 1010, 1110 lock automatic gain control (AGC) at block 1400. Following transmission, the receiver 1104 listens, at block 1500, for any reflections 1103 of the training signal emitted by the transmitter 1101. Similarly, the receiver 1114 listens for any reflections 1113 from the transmitter 1111 and notes any delays in the received signals. At this stage the received signal is forwarded to the OFDM demodulator where the signal is converted to the frequency domain and channel estimation 1106, 1116 (see block 1600) is performed in order to arrive at a cancellation FIR response. At block 1700, the cancellation FIR response is converted back into a time domain signal by way of an Inverse Fast Fourier Transform (IFFT) block 1107, 1117.

At block 1800, the time delay of the delay blocks 1105, 1115 is set and the output of the IFFT is used to program the FIR's in order to produce weighted versions of the transmission signal. Once all the above steps have been carried out, the radios 1010, 1110 are calibrated and simultaneous data transmission and reception can commence.

In order to summarise, each radio 1010, 1110 executes a channel estimation routine whereby data in the form of a training signal is transmitted from radio A 1010 and radio B 1110 non-simultaneously and if any interference signals 1103 and 1113 are received by the same radio's receivers 1104 and 1114 during the transmission, an accurate model of the radio's transmission channels can be estimated and a correction signal can be generated removing the interfering signal. The correction signal is effectively a summation of delayed and weighted transmission signals which is subtracted from the received signal.

Through use of the method 1000 and radio communication system 600, 800, 1100 in accordance with the invention, it is believed that spectral efficiency will be doubled when compared to current FDD and TDD systems because transmission and reception take place simultaneously within the same frequency spectrum. This will result in increased data throughput. Furthermore, the invention obviates the need for diplexers or T/R switches which results in a simplified design and a component cost saving. Installation and commissioning is simplified because there is only one type of radio.

Furthermore, the invention makes use of standard off the shelf antennas. The required isolation is achieved external to the antenna geometry, allowing for cost advantages associated with standard off the shelf antennas. Since both ends of the link are identical, there is a configuration management cost saving during manufacturing. The cost of logistic support is also halved.

1. A wireless radio transceiver which includes:
at least one radio transmitter and at least one radio receiver;
a transmitter antenna coupled to the transmitter and a neighbouring receiver antenna coupled to the receiver, the transmitter and receiver antennas being disposed adjacent to each other such that a space is defined therebetween, the transmitter and receiver antennas being configured to communicate simultaneously with an identical remote radio transceiver;
electromagnetic wave attenuation structure which is disposed at least partially within the space defined between the transmitter and receiver antennas, thereby attenuating microwave energy transmitted from the transmitter antenna to the receiver antenna; and
a reflection interference cancellation digital signal processing module which is configured to cancel interference in a signal received by the receiver, wherein the interference is as a result of reflection of a signal transmitted by the transmitter.

2. The wireless radio transceiver of claim 1, which includes a radome which is operatively arranged over the transmitter and receiver antennas, the radome including an electromagnetic wave attenuating structure which is operatively in register with the space defined between the transmitter antenna and the receiver antenna.

3. The wireless radio transceiver of claim 1, in which the transmitter and receiver are configured to transmit and receive, respectively, data within the same frequency band with the identical radio transceiver.

4. The wireless radio transceiver of claim 1, which is configured to transmit and receive data simultaneously via the transmitter and the receiver, thus operating in full duplex mode.

5. The wireless radio transceiver of claim 1, which is configured to communicate with the identical remote radio transceiver by way of a point-to-point configuration.

6. The wireless radio transceiver of claim 1, in which the transmitter and receiver antennas are cross-polarised antennas.

7. The wireless radio transceiver of claim 6, which includes a pair of transmitters coupled to the transmitter antenna via a transmitter OMT (Orthogonal Mode Transducer) and a pair of receivers coupled to the receiver antenna via a receiver OMT.

8. The wireless radio transceiver of claim 7, in which the reflection interference cancellation module is an adaptive digital signal processing module.

9. The wireless radio transceiver of claim 8, in which the digital signal processing module employs channel estimation.

10. The wireless radio transceiver of claim 1, which includes a DSP (Digital Signal Processor) operable to:
transmit, using the transmitter, a training signal to a remote wireless radio transceiver whilst the receiver is not communicating with the remote wireless radio transceiver;
receive, using the receiver, an interference signal following transmission of the training signal; and
calculate an interference correction signal which operatively is used to cancel interference on a signal received by the receiver.

11. A radio communication system which includes a pair of identical wireless radio transceivers of claim 1.

12. The communication system of claim 11, in which the pair of identical wireless radio transceivers are arranged in a point-to-point configuration.

13. The communication system of claim 11, in which the pair of identical wireless radio transceivers are configured for full duplex, bidirectional, simultaneous communication within the same frequency band.

14. The communication system of claim 11, in which the pair of identical wireless radio transceivers are configured to communicate using Orthogonal Frequency Domain Multiplexing (OFDM) modulation or Single Carrier (SC) Modulation.

15. A method of optimising spectral efficiency of a wireless radio transceiver of claim 1, the method including:
transmitting, using the transmitter, a training signal to a remote wireless radio transceiver whilst the receiver is not communicating with the remote wireless radio transceiver;
receiving, using the receiver, an interference signal following transmission of the training signal; and
calculating, by a DSP (Digital Signal Processor) of the wireless radio transceiver, an interference correction signal which operatively is used to cancel interference on a signal received by the receiver.

16. The method of claim 15, in which the step of calculating the interference correction signal includes estimating a cancellation Finite Impulse Response (FIR) using channel estimation.

17. The method of claim 15, which includes
initiating simultaneous transmission by the transmitter and reception by the receiver; and
correcting a signal received by the receiver using information derived from the interference correction signal.

18. The method of claim 15, in which correcting the signal received by the receiver includes subtracting a manipulated version of the transmitted signal from the received signal.

19. The method of claim 18, in which correcting subtracting the manipulated version includes subtracting a combination of delayed and weighted versions of the transmitted signal from the received signal.

20. A method of optimising spectral efficiency of a radio communication system of claim 11, the method including:
training the receiver of a proximate radio transceiver by transmitting a training signal to the receiver of the remote radio transceiver, using the transmitter of the proximate radio transceiver;
estimating an interference correction signal using a DSP module of the proximate radio transceiver;
initiating simultaneous transmission by the transmitters of both radio transceivers; and
correcting a signal received by the receivers using information derived from the interference correction signal.

21. The method of claim 20, in which calculating the interference correction signal includes a digital signal processing step performed by a reflective interference cancellation digital signal processing module and which includes making a digital representation of a time domain received signal and converting the signal to the frequency domain in order to perform channel estimation.

22. The method of claim 15, which includes providing an electromagnetic wave attenuating material between the transmitter and receiver antennas of the or each wireless radio transceiver.
